(19) United States
(12) Patent Application Publication
(10) Pub. No.: US 2009/0237687 A1
(43) Pub. Date: Sep. 24, 2009

(54) Printing apparatus capable of double-side printing

(75) Inventor: Atsushi Takata, Ibaraki- Ken (JP)

Correspondence Address: THE NATH LAW GROUP, 112 South West Street, Alexandria, VA, 22314, US

(73) Assignee: RISO KAGAKU CORPORATION, Tokyo (JP)

(21) Appl. No.: 12/382,531

(22) Filed: Mar. 18, 2009

(30) Foreign Application Priority Data
Mar. 21, 2008 (JP) 2008-074069

(51) Int. Cl. G06F 15/00

(52) U.S. Cl. 358/1.9

(57) ABSTRACT

A printing apparatus is provided with a circulating transportation route and capable of performing a double-side print process by printing the main side of a print sheet, reversing the print sheet with the printed main side, and printing the back side of the print sheet. Particularly, the image data blocks for printing the main side and back side of each print sheet are stored in separate areas of a page memory unit such that the image data blocks for printing the main sides of a plurality of print sheets are successively and continuously stored in the page memory unit one after another without an interval therebetween, and the image data blocks for printing the back sides of the plurality of print sheets are stored in the same manner as for the main sides. It is therefore possible to prevent fragmentation from occurring during the double-side printing process.

### BACKGROUND OF THE INVENTION

1. Field of the Invention

The present invention relates generally to a printing apparatus, and more particularly to a memory management technique during double-side printing.

2. Description of the Background Art

There are known printing apparatuses which are provided with a circulating transportation route in a housing and capable of performing a double-side print process by inverting a print sheet during circulation transportation after printing the main side of the print sheet, and printing the back side thereof, as described in Japanese Patent Published Application No. 2001-282050. This Published Application also describes a double-side print process which is applicable when printing print sheets of different sizes.

When a printing apparatus performs print process, image data is generated in a form which can be processed by the print mechanism of the printing apparatus on the basis of print data which is transmitted from a host computer or the like. If the print process is started just after generating image data for the main side in a double-side print mode, the print process may be interrupted when the generation of image data cannot keep pace with the print process during printing the back side. Because of this, the process of printing the main side is started after completing the generation of the image data for both the main side and the back side.

The image data as generated is stored in a page memory which is provided in the printing apparatus, and successively transmitted to the print mechanism while performing timing adjustment in synchronization with the operations of the print mechanism and transportation mechanism. Then, the print mechanism prints images on a print sheet in accordance with the image data. After transferred to the page memory, the image data is deleted from the page memory to provide a free area which is used to store a subsequent page.

Recently, in order to realize a high speed print process, in many cases, image data is transferred by burst transfer cycles in which a predetermined number of data words can be continuously and automatically transferred only by designating one address as a start address. For effectively performing the burst transfer, it is necessary that a plurality of data blocks to be transferred have to be continuously arranged in the page memory on a page-to-page basis.

Image data of the main side is generated and then image data of the back side is generated for each print sheet when performing double-side printing of a plurality of pages. That is, image data blocks are successively generated for the main side of the first sheet, the back side of the first sheet, the main sides of the second sheet, the back side of the second sheet, the main sides of the third sheet, the back side of the third sheet, and so forth in this order, and successively stored in the page memory also in this order. In this case, the image data blocks are continuously stored in the page memory with no space between each adjacent blocks as illustrated in FIG. 6A for the purpose of making effective the advantages of burst transfer.

However, in the case of the double-side print mode, the image data blocks are not necessarily printed in the order that they are stored. For example, in the case where a plurality of print sheets can be transported at the same time in a transportation route as described in Japanese Patent Published Application No. 2001-282050, the main side of a page may be printed alternately the back side of another page in order to improve the print efficiency, except for the timing adjustment periods just after starting the print process and just before finishing the print process in which a print sheet is printed with no previous print sheet or no subsequent print sheet.

For example, in the case where three print sheets can be transported at the same time, the print process is performed in print cycles to print the “first main side”, “ ”, the “second main side”, the “first back side”, the “third main side”, the “second back side”, the “fourth main side”, the “third back side”, the “fifth main side”, . . . in this order. In this description, the “N-th main side” means that the main side of the N-th print sheet is printed, the “N-th back side” means that the back side of the N-th print sheet is printed, and the “ ” means that the no print sheet has been fed in the corresponding print cycle for timing adjustment in the corresponding print cycle. Likewise, in the case where four print sheets can be transported at the same time, the print process is performed in print cycles to print the “first main side”, “ ”, the “second main side”, “ ”, the “third main side”, the “first back side”, the “fourth main side”, the “second back side”, the “fifth main side”, the “third back side”, the “sixth main side”. . . in this order.

In these cases, the image data blocks are deleted in the same order as they are printed, such that in the first example the image data blocks are successively deleted for the “first main side”, the “second main side”, the “first back side”, . . . in this order. Because of this, for example, fragmentation (an unused space f1) occurs in the page memory after printing the main side of the second sheet as illustrated in FIG. 6B. Also, in the case of the second example, the image data blocks are successively deleted from the page memory in the same order as printing the “first main side”, the “second main side”, the “third main side”, the “first back side”, the “fourth main side”. . . , such that for example, fragmentation (unused spaces f2 and f3) occurs in the page memory after printing the main side of the third sheet as illustrated in FIG. 6C.

These unused spaces occurring after deletion of image data blocks may be used to store subsequent image data blocks when printing the same size print sheets in the double-side print mode. However, in the case where different size print sheets are mixedly processed in the double-side print mode as described in Japanese Patent Published Application No. 2001-282050, the unused space(s) may not provide a continuous memory area having a sufficient size to store a next image data block. In this case, since an image data block is fragmented, it is impossible to perform high speed transfer by the use of the burst transfer process. In addition to this, from the view point of memory management, it is preferred to avoid fragmentation as much as possible.

On the other hand, as fragmentation is undesirable, it can be considered to rearrange image data blocks in the order that they are printed before storing them in the page memory for the purpose of avoiding fragmentation. However, the processing required for rearranging image data blocks is complicated and heavy.

### SUMMARY OF THE INVENTION

Taking into consideration the above circumstances, it is an object of the present invention to provide a printing apparatus capable of continuously storing image data blocks in a page memory without causing fragmentation, and thereby effectively performing high speed transfer by the use of the burst transfer mechanism.

In order to accomplish the object as described above, the printing apparatus according to the present invention is provided with a circulating transportation route and capable of performing a double-side print process by printing the main side of a print sheet, reversing the print sheet with the printed main side in the circulating transportation route, and printing the back side of the print sheet. This printing apparatus comprises: an image data generation unit operable to successively generate image data blocks for printing the main side and back side of each print sheet; a page memory unit operable to provide a memory space for storing a plurality of image data blocks; a print processing unit operable to perform the double-side print process on the basis of the image data blocks stored in the page memory unit; and an image data transfer unit operable to transfer the image data blocks from the page memory unit to the print processing unit in accordance with the order of printing pages which is set up by the control unit. Particularly, in accordance with the present invention, the image data blocks for printing the main side and back side of each print sheet are stored in separate areas of the page memory unit such that while the image data blocks for printing the main sides of a plurality of print sheets are successively and continuously stored in the page memory unit one after another without an interval therebetween, the image data blocks for printing the back sides of the plurality of print sheets are successively and continuously stored in the page memory unit one after another without an interval therebetween.

In a preferred embodiment, the page memory unit is used as a ring buffer in which the address of the memory space wraps around from the last address to the first address thereof such that the main or back sides of the plurality of print sheets are successively stored in the page memory unit in a logically seamless manner. Also, in accordance with a preferred embodiment of the present invention, the image data transfer unit is capable of transferring the image data blocks from the page memory unit to the print processing unit by the use of a burst transfer mechanism.

Furthermore, in accordance with a preferred embodiment of the present invention, the image data blocks for printing the main sides of print sheets are coherently stored in an area of the page memory unit and transferred therefrom in the order that these blocks are stored. This is true also in the area for storing the image data blocks for printing the back sides of the print sheets. Because of this, irrespective of the order of printing pages in the double-side printing mode, there is no fragmentation in the page memory unit. Particularly, this is advantageous for performing high speed burst transfer of the image data. In addition, the memory space of the page memory unit can be effectively used by making use of the page memory unit as a ring buffer.

### BRIEF DESCRIPTION OF THE DRAWINGS

The objects and features of the present invention will become more apparent from consideration of the following detailed description taken in conjunction with the accompanying drawings in which:

FIG. 1 is a schematic diagram for showing a print sheet transportation route of a printing apparatus in accordance with an embodiment of the present invention.

FIG. 2 is a diagram for schematically showing a paper feed transportation route and a circulating transportation route in accordance with the embodiment of the present invention.

FIG. 3 is a block diagram showing the functional configuration of the printing apparatus in accordance with the embodiment of the present invention.

FIG. 4A is an explanatory view for showing the print schedule for double-side printing in the case where three print sheets can be concurrently transported in the circulating transportation route in accordance with the embodiment of the present invention.

FIG. 4B is an explanatory view for showing the print schedule for double-side printing in the case where four print sheets can be concurrently transported in the circulating transportation route in accordance with the embodiment of the present invention.

FIG. 5A is an explanatory view for showing in what fashion the image data blocks for double-side printing are stored in the page memory just after starting the print process in accordance with the embodiment of the present invention.

FIG. 5B is an explanatory view for showing the arrangement of image data blocks stored in the page memory in which there is no fragmentation during double-side printing in accordance with the embodiment of the present invention.

FIG. 5C is an explanatory view for showing the arrangement of image data blocks stored in the page memory in which there is no fragmentation during double-side printing in accordance with the embodiment of the present invention.

FIG. 5D is an explanatory view for showing a ring buffer structure in the page memory in accordance with the embodiment of the present invention.

FIG. 6A is an explanatory view for showing the arrangement of image data blocks successively stored in a page memory during double-side printing in accordance with a conventional technique.

FIG. 6B is an explanatory view for showing fragmentation occurring in the page memory during double-side printing in accordance with the conventional technique.

FIG. 6C is an explanatory view for showing fragmentation occurring in the page memory during double-side printing in accordance with the conventional technique.

### DESCRIPTION OF THE PREFERRED EMBODIMENTS

In the following description, an embodiment of the present invention will be explained in conjunction with the accompanying drawings.

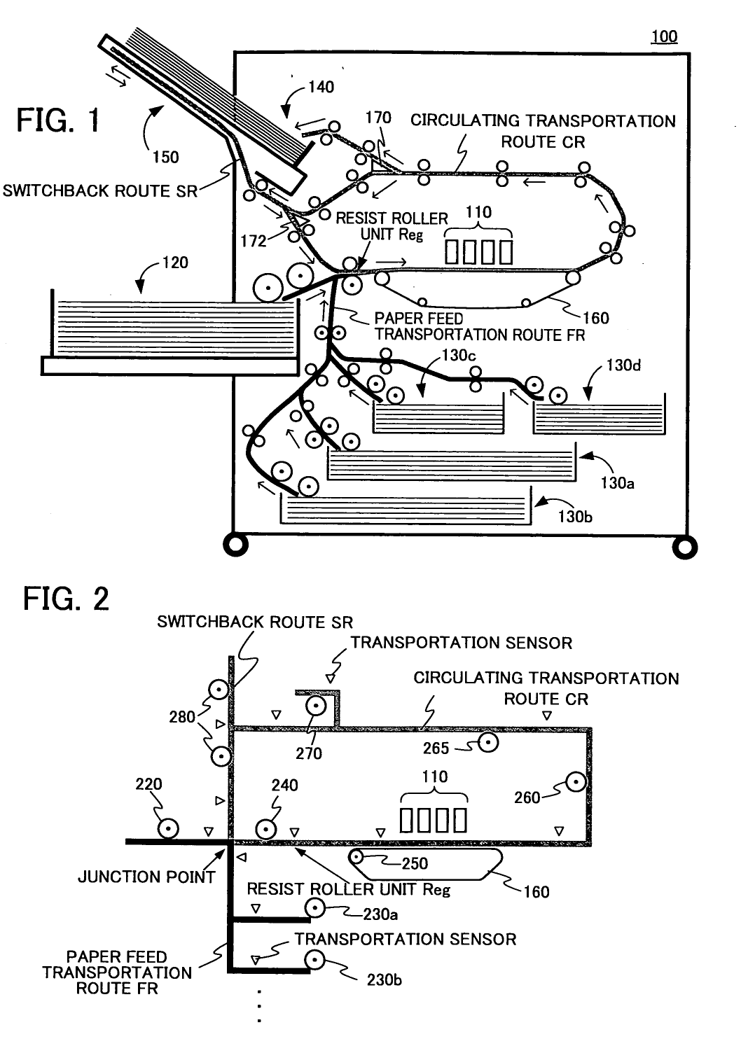

FIG. 1 is a schematic diagram for showing a print sheet transportation route of a printing apparatus 100 in accordance with the present invention. As shown in the same figure, the printing apparatus 100 is capable of performing the double-side print process, and provided with a paper feed mechanism for feeding print sheets including a paper feed side tray 120 exposed from the side surface of the housing of the printing apparatus 100, and paper feed mechanisms respectively for a plurality of paper feed trays 130a, 130b, 130c and 130d which are located inside the housing. Each of the paper feed mechanisms is provided with a paper size sensor capable of detecting the size of a print sheet which is fed. Furthermore, a discharge port 140 is provided as a discharge mechanism for discharging print sheets which have been printed.

In the case of the present embodiment, the printing apparatus 100 is a line color inkjet printer provided with a plurality of print heads 110 each of which is formed to span the route in the direction perpendicular to the paper transportation direction, and has a lot of nozzles which serve to eject black or color ink respectively in order to print images of the respective colors on a line-by-line basis. However, the present invention is not limited to this type of printer, but also applicable to other types of printing apparatuses. For example, the present invention can be applied to serial inkjet printers, laser printers and so forth.

A print sheet fed from either the paper feed side tray 120 or one of the paper feed trays 130 is transported along a paper feed transportation route FR by a transportation mechanism such as roller units to a resist roller unit Reg which defines a reference position at which the leading edge of each print sheet is aligned. The head units 110 having a plurality of print heads are located in the downstream side of the paper transportation route as seen from the resist roller unit Reg. The print sheet is printed to form an image with ink ejected from the respective print heads on a line-by-line basis, while being transported at a predetermined speed in accordance with the printer option settings on a conveyor belt 160 which is located on the opposite side to the print heads 110 with the print sheet therebetween.

The print sheet which has been printed is further transported in the housing by the transportation mechanism such as roller units. In the case of a one-side print mode for printing only one side of the print sheet, the print sheet is transferred directly to the discharge port 140 and stacked on a catch tray 150 as a receiver at the discharge port 140 with the printed side down. The catch tray 150 is provided to protrude from the housing with a certain thickness. The catch tray 150 is slanted with a lower upright wall at which print sheets which have been printed and discharged from the discharge port 140 are neatly aligned under their own weight with the upright wall serving as a reference of alignment.

In the case of a double-side print mode for printing both sides of the print sheet, the print sheet is not transferred to the discharge port 140 just after printing the main side (the first printed side is called “main side”, and the next printed side is called “back side” in this description), but is transported again in the housing. Because of this, the printing apparatus 100 is provided with a shunt mechanism 170 for selectively switching the transfer route for printing on the back side. After printing on the main side, the shunt mechanism 170 transfers the print sheet to a switchback route SR such that the print sheet is reversed with respect to the transportation route by the switchback operation. The print sheet is transferred to the resist roller unit Reg again by the transportation mechanism such as roller units through a switching mechanism 172, and printed on the back side in the same manner as on the main side. After printing on the back side, the print sheet with images printed on the both sides is transferred to the discharge port 140, and stacked on the catch tray 150 serving as the receiver at the discharge port 140.

Incidentally, in the case of the present embodiment, the switchback operation is performed in the double-side print mode by the use of the space formed in the catch tray 150. The space formed in the catch tray 150 is designed such that the print sheet cannot be accessed externally during the switchback operation. By this configuration, it is avoided that a user extracts the print sheet during the switchback operation by mistake. Furthermore, since the catch tray 150 is indispensable for the printing apparatus 100, there is no need for a separate space, which would be particularly provided in the printing apparatus 100 for the switchback operation, while making use of the space formed in the catch tray 150 for the switchback operation. Accordingly, it is possible to prevent the size of the housing from increasing for the purpose of implementing the switchback operation. Moreover, since the discharge port and the switchback route are separated, the paper discharge operation can be performed in parallel with the switchback operation.

In the double-side print mode of the printing apparatus 100, the print sheet is transferred to the resist roller unit Reg, which defines the reference position at which the leading edge of the print sheet is aligned, not only before printing the main side thereof but also before printing the back side. Because of this, just before the resist roller unit Reg, there is a junction point between the transportation route for the print sheet just fed from the paper feed side tray and the transportation route for the print sheet with the main side having been printed.

The paper transportation route is divided into the paper feed transportation route FR, which is located on the paper feed mechanism side as seen from this junction point, and the remaining transportation route which is referred to herein as the circulating transportation route CR. FIG. 2 is a diagram for schematically showing the paper feed transportation route FR and the circulating transportation route CR. Some of roller units forming the transportation mechanism are not illustrated for the sake of clarity in explanation.

The paper feed transportation route FR is provided with a side paper feed drive unit 220 for feeding paper from the paper feed side tray 120, and a first tray drive unit 230a, a second tray drive unit 230b, . . . respectively for feeding paper from the paper feed trays 130a, 130b, 130c and 130d. Each transportation unit comprises a transportation mechanism constructed by a plurality of roller units to extract print sheets one after another from the paper feed tray corresponding thereto and transfer the print sheets to the resist roller unit Reg. The respective transportation units can be driven independently from each other, and perform necessary operation in order to implement the paper feed mechanism.

In addition, the paper feed transportation route FR is provided with a plurality of transportation sensors with which paper jam can be detected along the paper feed transportation route FR. Each transportation sensor is a sensor which can determine if a print sheet is present and detect the leading edge of the print sheet. For example, the plurality of transportation sensors are located at appropriate intervals on the paper feed transportation route. Paper jam can be detected if the transportation sensor located on the transportation side does not detect the print sheet a predetermined time after the transportation sensor located on the paper feeding side detects the print sheet. Furthermore, paper jam (paper feeding error) can also be detected if the transportation sensor located near the paper feed tray does not detect the print sheet a predetermined time after starting driving the side paper feed drive unit 220, the first tray drive unit 230a or the like.

By providing the transportation sensor near each paper feed tray, it is possible to determine whether or not paper jam occurs in the paper feed transportation route FR, and determine in what location of the paper feed transportation route FR the paper jam occurs.

Along the circulating transportation route CR, there are a resist drive unit 240 for receiving a print sheet at the resist roller unit Reg, a belt drive unit 250 for driving the conveyor belt 160 which is located in a position opposite the head units 110, first and second upper side transportation drive units 260 and 265 which are arranged on the circulating transportation route CR successively in the paper transportation direction, an upper side paper discharge drive unit 270 for transferring a printed sheet to the discharge port 140, and a switchback route drive unit 280 for drawing the printed sheet in the switchback route SR, reversing and transferring the printed sheet to the junction point between the circulating transportation route CR and the paper feed transportation route FR. Each of these transportation units is provided with a driving mechanism comprising one or more roller units, and serves to transport print sheets one after another along the transportation route. The respective transportation units can be driven independently from each other, and perform necessary operation in accordance with the transportation position of the print sheet.

The circulating transportation route CR is also provided with a plurality of transportation sensors with which paper jam can be detected along the circulating transportation route CR. Furthermore, it can be confirmed that each print sheet is transferred to the resist roller unit Reg in an appropriate manner. A transportation sensor is provided for each transportation unit, and thereby it is possible to determine in what location of the circulating transportation route CR the paper jam occurs.

Meanwhile, in the case of the present embodiment, a print sheet is fed to the printing apparatus 100 in advance of discharging the preceding print sheet, without waiting until the preceding print sheet is discharged, so that print sheets are successively fed and continuously printed at predetermined intervals. Because of this, a plurality of print sheets may be located in the circulating transportation route CR of the printing apparatus 100 at the same time, and print sheets may be located in both the circulating transportation route CR and the paper feed transportation route FR at the same time.

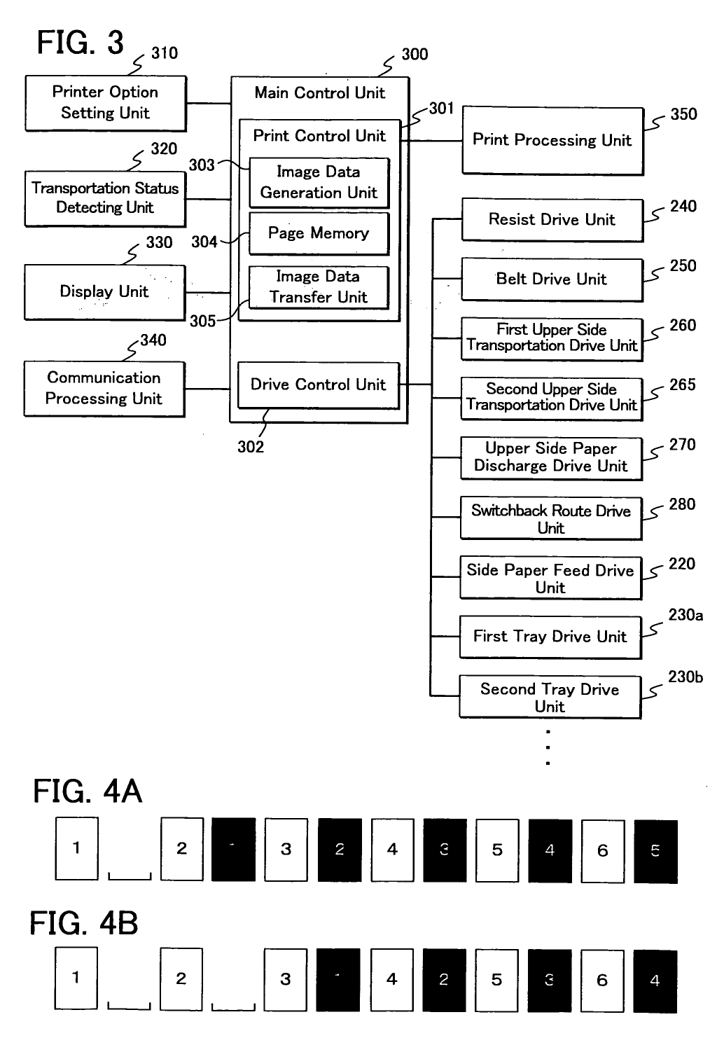

FIG. 3 is a block diagram showing the functional configuration of the printing apparatus 100. The printing apparatus 100 is provided with a main control unit 300 which includes a CPU, a memory and the like. The CPU runs a program loaded in the memory in order to implement a print control unit 301 and a drive control unit 302. Alternatively, the print control unit 301 and the drive control unit 302 may be implemented by means of hardware, or cooperation of hardware and software.

Also, the printing apparatus 100 is provided further with a printer option setting unit 310 for receiving the settings of the double-side or single-side print modes, paper size, resolution and so forth, a transportation status detecting unit 320 for detecting the transportation status of the print sheets on the transportation route on the basis of the signals output from the transportation sensors, a display unit 330 for displaying the information about the status of the printing apparatus, and a communication processing unit 340 for performing communication with a host computer or the like and receiving print data therefrom. The printer option setting unit 310 receives the print data as transmitted from the host computer connected to the printing apparatus 100, and accepts the settings of printer options as input by the user through an input panel (not shown in the figure).

The print control unit 301 generates image data in accordance with the printer option settings accepted by the printer option setting unit 310, and controls the print process performed by a print processing unit 350 comprising the print mechanism such as the print head. Because of this, the print control unit 301 is provided with an image data generation unit 303, a page memory 304 and an image data transfer unit 305.

The image data generation unit 303 generates image data, which can be processed by the print processing unit 350, on the basis of the print data received by the communication processing unit 340 and so forth. The page memory 304 is a memory capable of storing image data blocks for a plurality of pages, and provided with a memory unit and a controller unit for managing memory access. The image data transfer unit 305 serves to transfer the image data stored in the page memory 304 to the print processing unit 350 on a page-to-page basis, while performing timing adjustment. In the case of the present embodiment, the page memory 304 and the image data transfer unit 305 are connected through a PCI bus or the like, and support a burst transfer mechanism which enables successively transferring a plurality of data blocks on the basis of an address. For effectively performing the burst transfer, it is necessary that the image data to be transferred to the image data transfer unit 305 has to be continuously arranged in the page memory 304 on a page-to-page basis.

The drive control unit 302 drives the respective units as described above, i.e., the resist drive unit 240, the belt drive unit 250, the first upper side transportation drive unit 260, the second upper side transportation drive unit 265, the upper side paper discharge drive unit 270, the switchback route drive unit 280, the side paper feed drive unit 220, the first tray drive unit 230a, the second tray drive unit 230b and so forth under the control of the print control unit 301.

Next, the management of the page memory 304 in the double-side print mode will be explained in accordance with the present embodiment. In the case of the present embodiment, as described above, when the print process is performed in the double-side print mode, while transporting the print sheet whose main side has been printed around the circulating transportation route CR, the subsequent page can be printed by feeding a print sheet. At this time, the main control unit 300 performs scheduling the printing order in accordance with the number of print sheets which can be concurrently transported in the circulating transportation route CR for the purpose of improving the printing efficiency.

For example, in the case where three print sheets can be concurrently transported in the circulating transportation route CR, as illustrated in FIG. 4A, the print process is performed in print cycles to print the “first main side”, “ ”, the “second main side”, the “first back side”, the “third main side”, the “second back side”, the “fourth main side”, the “third back side”, the “fifth main side”, the “fourth back side”, the “sixth main side”, the “fifth back side”. . . in this order. In FIG. 4A to FIG. 4D, N-th main side printing is indicated by a black numeral “N” on a white background, and N-th back side printing is indicated by a white numeral “N” on a black background. Interval slots are inserted in cycles where no print sheet is fed.

For example, in the case where four print sheets can be concurrently transported in the circulating transportation route CR and the switchback route SR as illustrated in FIG. 4B, the print process is performed in print cycles to print the “first main side”, “ ”, the “second main side”, the “third main side”, the “first back side”, the “fourth main side”, the “second back side”, the “fifth main side”, the “third back side”, the “sixth main side”, the “fifth back side”. . . in this order. Meanwhile, the number of print sheets which can be located in the circulating transportation route CR at the same time varies depending on the paper size and the like.

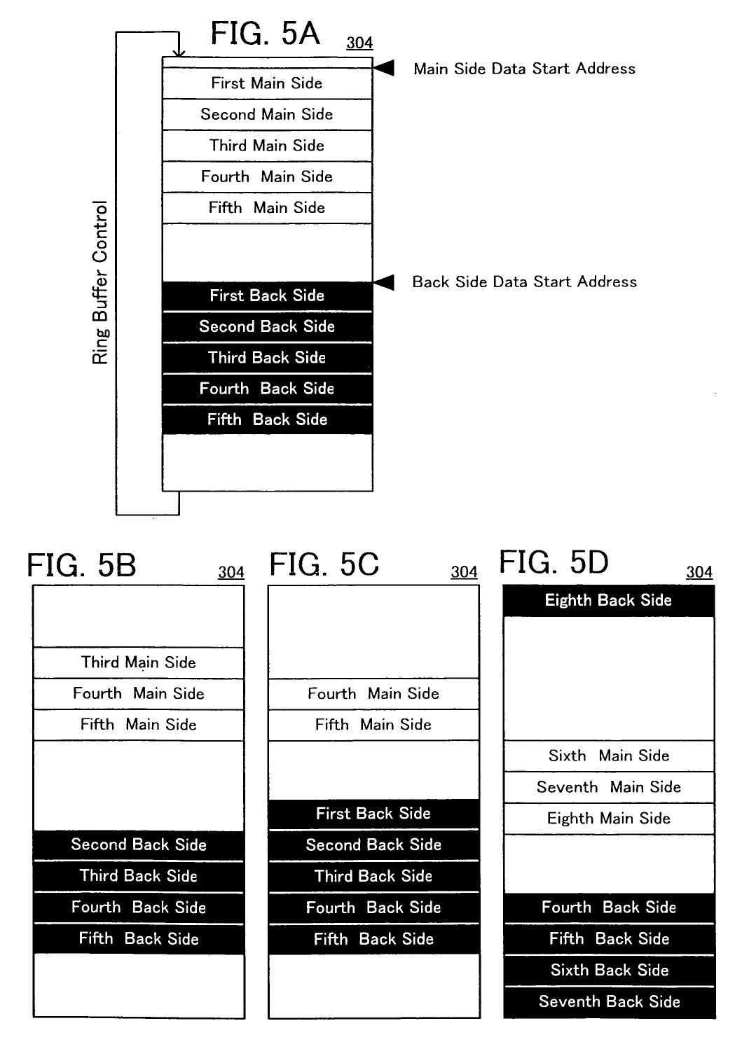

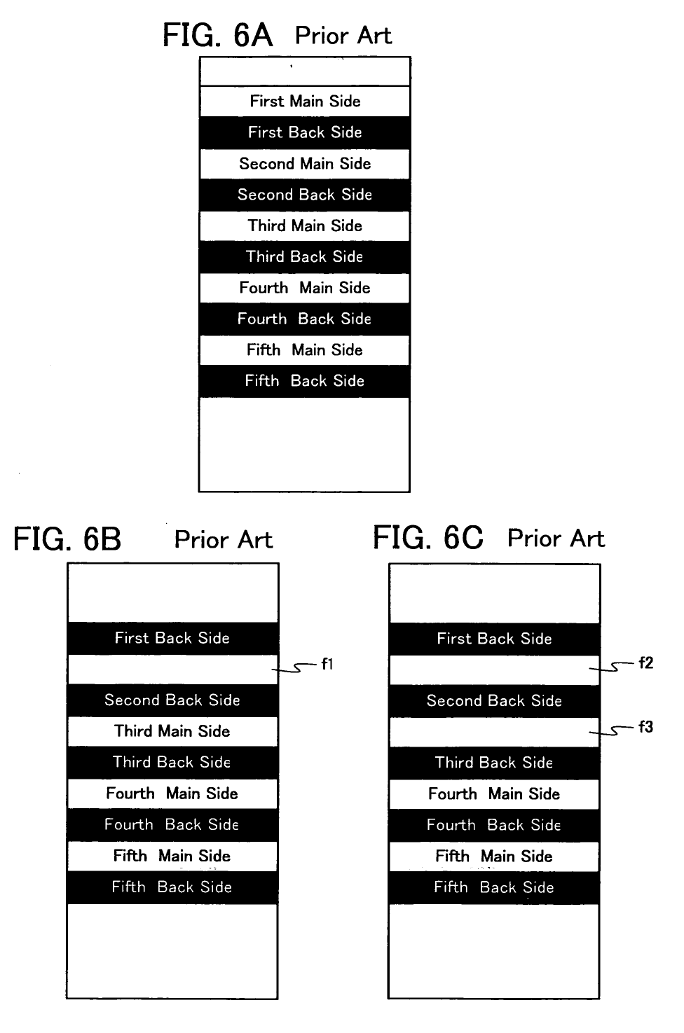

FIG. 5 is a view for explaining the management of the page memory 304 in accordance with the present embodiment. As illustrated in FIG. 5A, in the case of the present embodiment, the page memory 304 is divided into two areas having the substantially same size in the initial state. One of these two areas is defined to start from a main side data start address and used to store image data blocks for main sides of print sheets. The other area is defined to start from a back side data start address and used to store image data blocks for back sides of print sheets.

In this initial state, the image data blocks of the main sides which are generated by the drive control unit 302 are successively stored from the main side data start address. Also, the image data blocks of the back sides are successively stored from the back side data start address. The image data blocks which are transferred to the print processing unit 350 by the image data transfer unit 305 are deleted one after another.

By storing the image data blocks in this fashion, in the storage area for the main side image data and the storage area for the back side image data, the image data blocks are deleted in the order that these blocks are stored. Because of this, even if the double-side print process is performed in the order as illustrated in FIG. 4A, for example after printing the main side of the second sheet, fragmentation does not occur as illustrated in FIG. 5B in the page memory 304 due to an unused space unlike the conventional case.

In addition to this, if the double-side print process is performed in the order as illustrated in FIG. 4B, for example after printing the main side of the third sheet, fragmentation does not occur as illustrated in FIG. 5C in the page memory 304 due to an unused space unlike the conventional case. When the print process is proceeding thereafter, fragmentation does also not occur in the page memory 304. As a result, even in the case where different size print sheets are mixedly processed in the double-side print mode, it is possible to continuously store image data blocks and perform high speed transfer by the use of the burst transfer mechanism.

Furthermore, in the case of the present embodiment, the page memory 304 is used as a ring buffer or a circular buffer which is used as if it were connected end-to-end. Because of this, as illustrated in FIG. 5D, the storage area for the main side image data and the storage area for the back side image data are not fixed, but shifted in the page memory 304 in synchronization with the progress of the print process. By this configuration, while the high speed transfer of image data blocks is possible, it is possible to effectively use the storage area of the page memory 304. Meanwhile, from the page memory 304 in which valid image data blocks are stored as illustrated in FIG. 5D, the image data blocks are read in the order as the “sixth main side”, the “fourth back side”, the “seventh main side”, the “fifth back side”, the “eighth main side”, the “sixth back side”, . . . the “eighth back side”.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

What is claimed is:

1. A printing apparatus provided with a circulating transportation route and capable of performing a double-side print process by printing the main side of a print sheet, reversing the print sheet with the printed main side in the circulating transportation route, and printing the back side of the print sheet, the printing apparatus comprising:
an image data generation unit operable to successively generate image data blocks for printing the main side and back side of each print sheet;
a page memory unit operable to provide a memory space for storing a plurality of image data blocks;
a print processing unit operable to perform the double-side print process on the basis of the image data blocks stored in the page memory unit;
a control unit operable to set up the order of printing pages during performing the double-side print process; and
an image data transfer unit operable to transfer the image data blocks from the page memory unit to the print processing unit in accordance with the order of printing pages which is set up by the control unit,
wherein the image data blocks for printing the main side and back side of each print sheet are stored in separate areas of the page memory unit such that while the image data blocks for printing the main sides of a plurality of print sheets are successively and continuously stored in the page memory unit one after another without an interval therebetween, the image data blocks for printing the back sides of the plurality of print sheets are successively and continuously stored in the page memory unit one after another without an interval therebetween.

2. The printing apparatus as claimed in claim 1, wherein
the page memory unit is used as a ring buffer in which the address of the memory space wraps around from the last address to the first address thereof such that the main or back sides of the plurality of print sheets are successively stored in the page memory unit in a logically seamless manner.

3. The printing apparatus as claimed in claim 1, wherein
the image data transfer unit transfers the image data blocks from the page memory unit to the print processing unit by the use of a burst transfer mechanism.
